(19) United States
(12) Patent Application Publication
(10) Pub. No.: US 2016/0063337 A1
(43) Pub. Date: Mar. 3, 2016

(54) CODE EXTRACTING METHOD, CODE EXTRACTING DEVICE AND PROGRAM

(71) Applicant: Hiroshi TAMURA, Kashiwazaki-shi (JP)

(72) Inventor: Hiroshi TAMURA, Kashiwazaki-shi (JP)

(21) Appl. No.: 14/409,326

(22) PCT Filed: Jun. 17, 2014
(86) PCT No.: PCT/JP2014/066054

§ 371 Date: Dec. 18, 2014

(30) Foreign Application Priority Data
Jun. 17, 2013 (JP) 2013-126501

(51) Int. Cl. G06K 9/18; G06K 9/00; G06K 9/62; G06K 9/46

(52) U.S. Cl. CPC G06K 9/18; G06K 9/46; G06K 9/00442; G06K 9/6201

(57) ABSTRACT

A code extracting device (100) includes an input unit (110), a control unit (120), a storing unit (130), and a display unit (140). Data which shows a document and a drawing corresponding to the document is recorded in the storing unit (130). The control unit (120) extracts codes respectively described in the document and the drawing in accordance with the data showing the document and the drawing which is stored in the storing unit (130), compares the extracted codes of the document with the extracted codes of the drawing, extracts the codes which respectively correspond to each other and displays the extracted codes on the display unit (140).

### TECHNICAL FIELD

The present invention relates to a method, a device and a program for extracting a code described in a drawing by referring to a document and the drawing corresponding to the document.

### BACKGROUND ART

As this kind of device, the applicant files patent literature 1 in which the invention relating to an intellectual property management device is disclosed.

The intellectual property management device includes an input part which inputs data of a specification and a drawing in a patent application document including the specification and the drawing, a control part which extracts codes (character strings formed with numeric characters or alphabets) from the drawing and extracts names (character strings expressed by various kinds of languages) corresponding to the codes from the specification and a display part which displays on the drawing the names extracted by the control part together with the codes corresponding thereto.

FIG. 5 shows one example of the drawing displayed in the display part.

Ordinarily, only the codes are shown in the drawing of the patent application document. However, when the above-described intellectual property management device is used, as shown in FIG. 5, the codes and the names corresponding to the codes are displayed on the display part. Accordingly, when the specification is read, members respectively designated by the codes can be easily grasped by referring to the drawing.

### CITATION LIST

### Patent Literature

Patent Literature 1: JP-A-2013-92916

### SUMMARY OF INVENTION

### Technical Problem

When the codes described in the drawing are read, in most case, an (OCR: Optical Character Recognition) device is used. Specifically, the printed out drawing is read by a scanner, contents of the drawing are converted into digital data and the optical character recognition device is used to read the codes in the drawing from the digital data.

However, since the optical character recognition device decides whether or not an object to be recognized is a code merely in accordance with a form, even when the object is not the code, if its form is similar to the code, the optical character recognition device may sometimes erroneously recognize the object as the code. For instance, below-described cases are exemplified.
(1) When a through hole is provided which passes through a member described in the drawing, an opening of the through hole is expressed by an ellipse or a circle on the drawing. In this case, the ellipse or the circle may be sometimes erroneously recognized as “0 (zero)”.
(2) When a longitudinal line is described as an outline in the drawing, if the longitudinal line is short, the longitudinal line may be sometimes erroneously recognized as “1”.
(3) When two short longitudinal lines which are described in (2) are drawn in parallel, the short longitudinal lines may be sometimes erroneously recognized as “11”.
(4) When the ellipse or the circle showing the through hole which is described in (1) is drawn in the right side of the short longitudinal line as the outline which is described in (2), the ellipse or the circle and the short longitudinal line may be sometimes erroneously recognized as “10”.
(5) When an alphabet is used as a code, “B” may be sometimes erroneously recognized as “3”.

As described above, usually, even when the optical character recognition device is used, the codes in the drawing cannot be frequently precisely extracted.

The present invention is devised by considering the above-described problems in the usual character recognition and it is an object of the present invention to provide a code extracting method, a code extracting device and a program for carrying out the above-described method which make it possible to precisely extract codes in a drawing even when an optical character recognition device is used.

### ADVANTAGEOUS EFFECTS OF INVENTION

### Solution to Problem

In order to solve the problem, the invention provides a method for extracting codes in a drawing comprising:
a first step of extracting codes described in a document;
a second step of extracting codes described in the drawing corresponding to the document;
a third step of comparing the codes extracted in the first step with the codes extracted in the second step; and
a fourth step of extracting the codes respectively corresponding to each other in the third step.

It is preferable that the method further comprises a fifth step of extracting the codes that do not respectively correspond to each other in the third step.

Further, the invention provides a code extracting device comprising an input unit; a control unit; a storing unit; and a display unit, wherein in the storing unit, data is recorded which shows a document and a drawing corresponding to the document inputted through the input unit, and the control unit extracts codes respectively described in the document and the drawing in accordance with the data showing the document and the drawing which is stored in the storing unit, compares the extracted codes of the document with the extracted codes of the drawing, extracts the codes which respectively correspond to each other and displays the extracted codes on the display unit.

It is preferable that the control unit compares the extracted codes of the document with the codes of the drawing and extracts the codes which do not respectively correspond to each other.

Further, the invention provides a program which allows a computer to carry out a method for extracting codes described in a document and a drawing corresponding to the document, the program comprising:
a first process of extracting the codes described in the document;
a second process of extracting the codes described in the drawing;
a third process of comparing the codes extracted in the first process with the codes extracted in the second process; and
a fourth process of extracting the codes respectively corresponding to each other in the third process.

It is preferable that the program further comprises a fifth process of extracting the codes that do not respectively correspond to each other in the third process.

### Advantageous Effects of Invention

The code extracting method, the code extracting device and the program for carrying out the code extracting method according to the present invention obtain below-described effects.

As described above, the data of the codes in the drawing which are read by using the optical character recognition device includes data of codes which are not actually codes and are erroneously recognized as the codes.

As compared therewith, since data of contents of a document is not obtained via the optical character recognition device, but characters electronically converted into data are directly read, the data of the contents of the document does not include erroneously recognized codes, which is different from the read data of the codes in the drawing.

Accordingly, codes in the drawing corresponding to codes in the document can be taken not as erroneously recognized codes but as right codes.

As described above, according to the code extracting device and the code extracting method of the present invention, since the codes read from the drawing are compared with the codes in the document, the codes which are erroneously recognized and read can be eliminated and only the right codes can be left in the codes of the drawing.

### BRIEF DESCRIPTION OF THE DRAWINGS

FIG. 1 is a block diagram of a code extracting device according to a first embodiment of the present invention.

FIG. 2 is a flowchart of a code extracting method carried out by the code extracting device according to the present embodiment.

FIG. 3 shows a drawing as an object to be extracted of the code extracting device according to the first embodiment.

FIG. 4(A) shows an example of a list of codes in a specification extracted by a control unit.

FIG. 4(B) shows one example of a list of the codes in a drawing extracted by the control unit.

FIG. 5 shows one example of a drawing displayed in a display part of a conventional intellectual property management device.

### DESCRIPTION OF EMBODIMENTS

### First Embodiment

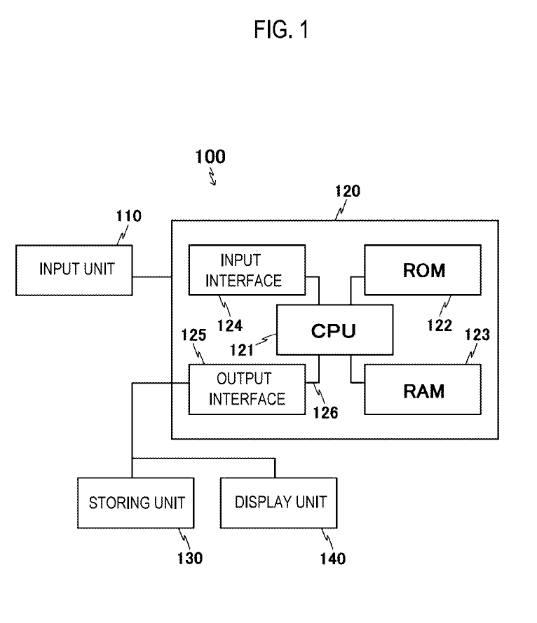

FIG. 1 is a block diagram of a code extracting device 100 according to a first embodiment of the present invention.

As shown in FIG. 1, the code extracting device 100 according to the present embodiment includes an input unit 110, a control unit 120, a storing unit 130 and a display unit 140.

The input unit 110 is formed with, for instance, a keyboard or a mouse. Necessary data or an instruction is inputted to the control unit 120 through the input unit 110.

The control unit 120 includes a central processing unit (CPU) 121, a first memory 122 formed with a ROM, a second memory 123 formed with a RAM, an input interface 124 which inputs various kinds of instructions and data to the central processing unit 121, an output interface 125 which outputs the result of processes carried out by the central processing unit 121 and a bus 126 which connects the central processing unit 121 to other component elements.

The first memory 122 stores therein various kinds of control programs executed by the central processing unit 121 and other fixed data. The second memory 123 stores various data and parameters and provides an operating area for the central processing unit 121, namely, stores data which the central processing unit 121 temporarily requires to execute the programs.

The central processing unit 121 reads the programs from the first memory 122 and executes the programs. Namely, the central processing unit 121 operates in accordance with the programs stored in the first memory 122. In the present embodiment, in the first memory 122, the program is stored which allows the central processing unit 121 to carry out a method for extracting codes in the drawing. The central processing unit 121 carries out the method for extracting the codes in the drawing in accordance with the program as described below.

The storing unit 130 is an external memory to the control unit 120. The storing unit 130 stores a result of calculation carried out by the control unit 120 and other data.

The display unit 140 is formed with, for instance, a liquid crystal display to display the result of the calculation carried out by the control unit 120 and other data on a screen.

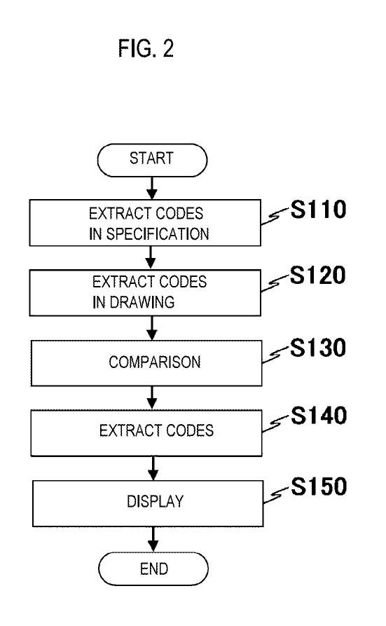

FIG. 2 is a flowchart of a code extracting method carried out by the code extracting device 100 according to the present embodiment.

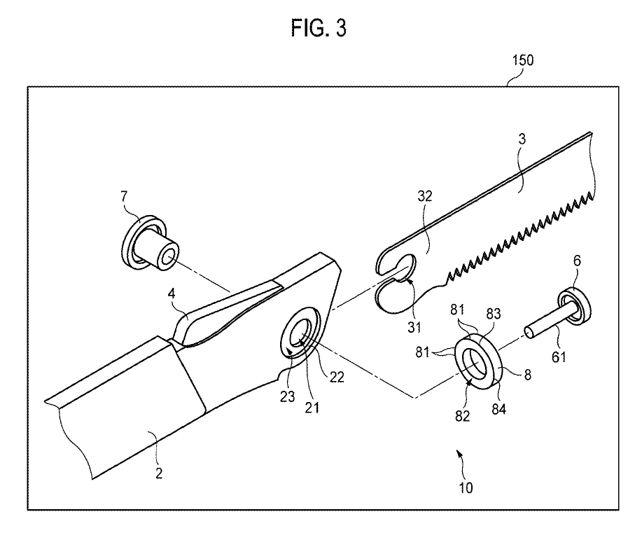

Now, referring to FIG. 2 and FIG. 3, an operation of the code extracting device 100 will be described below.

In a below-described example, the code extracting device 100 refers to the specification and the drawing for filing a patent application to extract codes in the drawing as objects to be extracted.

FIG. 3 shows the drawing 150 as an object to be extracted.

The codes in the drawing 150 are supposed to be previously read by using an optical character recognition device. Read data is supposed to be inputted to the control unit 120 through the input unit 110 and stored in the first memory 122. As described above, the read data includes the data of the codes which are not codes and are erroneously recognized as codes.

Similarly, data of contents of the specification is also supposed to be inputted to the control unit 120 through the input unit 110 and stored in the first memory 122. Since the data of the contents of the specification is not obtained via the optical character recognition device, the data of the contents of the specification does not include erroneously recognized codes, which is different from the read data of the codes of the drawing 150.

These data can be stored in the storing unit 130 in place of the first memory 122.

Initially, the control unit 120 refers to the data stored in the first memory 122, extracts the codes appearing in the specification (step S110) and further extracts names corresponding to the codes.

Specifically, from the top of text data, numeric characters or alphabets (namely, the codes) are started to be searched to extract as one name a character string which has the detected code as an origin and is located by the designated number of spaces before the detected numeric character. In such a way, when the character string is extracted by taking the numeric character or the alphabet as the origin, the name can be detected. Further, when the name is detected, the name and the code corresponding to the name (namely, a numeric character or an alphabet immediately after the character string extracted as the name) are coordinated with each other to register the name and the code as one record. After the one record is registered, the text data located after the registered code is taken as an object to be searched to resume a search of the codes. Subsequently, a process is repeated that every time the code is detected, one record is registered. Then, when the process reaches an end of the text data, the searching operation of the codes is finished. In such a way, a list in which the names corresponding to the codes are specified is prepared.

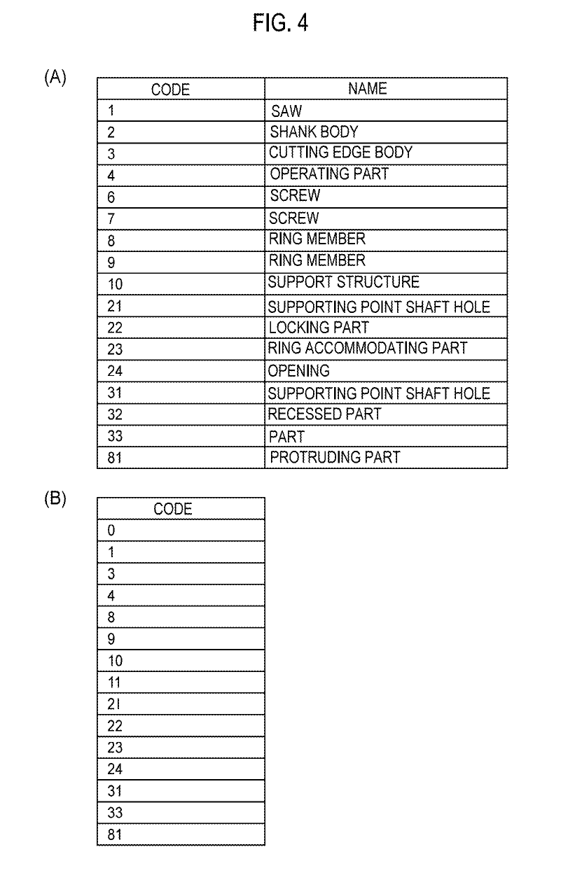

FIG. 4(A) shows an example of the list of the codes in the specification extracted by the control unit 120.

As shown in FIG. 4(A), the list is formed with two columns. A left column of the list is a column of the codes and a right column of the list is a column of the names. In the list, a plurality of rows is enumerated under a state that the codes appearing in the specification and the names corresponding to the codes are respectively arranged in one row. In the list shown in FIG. 4(A), the records are sorted in such a way that the codes are arranged from smaller codes to larger codes.

Then, the control unit 120 refers to the data of the drawing 150 stored in the first memory 122 to extract the codes appearing in the drawing 150 (step 120). Here, the codes described in the drawing 150 are read by using the optical character recognition device. As described above, in the read data, is included a code (this code may be sometimes referred to as a code X.) which is not originally drawn in the drawing and is erroneously extracted, or a code (this code may be sometimes referred to as a code Y.) which is drawn in the drawing, however, is not correctly read and is extracted as another numeric character or alphabet. Further, the read data may be sometimes lacking in a code (this code may be sometimes referred to as a code Z.) which is drawn in the drawing, however, is not extracted as a numeric character or alphabet.

FIG. 4(B) shows one example of a list of the codes in the drawing extracted by the control unit 120.

As shown in FIG. 4(B), the list is formed with one column. In the list shown in FIG. 4(B), the codes are sorted in such a way that the codes are arranged from smaller codes to larger codes.

Then, the control unit 120 compares the codes in the drawing 150 with the codes in the specification to decide whether or not the codes in the drawing and the codes in the specification mutually correspond (step S130). In accordance with the comparison, the codes X and Y can be discriminated in the list of the codes in the drawing. Further, the list of the codes in the drawing can be discriminated to be lacking in the code Z. For instance, in FIG. 4(B), the code “0”, the code “11” and the code “21(a first position designates L as an alphanumeric character” can be discriminated to be the erroneously extracted code X or the code Y. Further, in FIG. 4(B), “2”, “6” and “7” can be discriminated to be the codes Z which are not extracted.

Further, when the codes respectively correspond to each other, the control unit 120 extracts these codes (step S140). For instance, in FIG. 4(A) and FIG. 4(B), “1”, “3”, “4”, “8”, “9”, “10”, “22”, “23”, “24”, “31”, “32”, “33” and “81” are extracted as the corresponding codes.

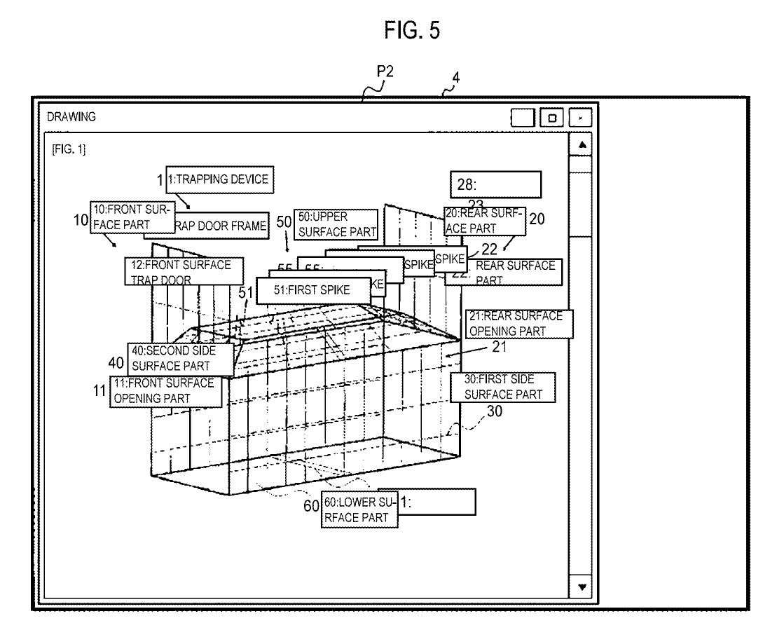

After that, the control unit 120 displays the codes extracted in the step S140 and the codes Z on the display unit 140 (step S150). Otherwise, as shown in FIG. 5, the control unit 120 displays the names corresponding to the codes at positions (in FIG. 5, positions adjacent to the codes) respectively corresponding to the codes on the drawing 150.

The code extracting device 100 according to the present embodiment exhibit below-described effects.

As described above, in the data of the codes in the drawing 150 read by using the optical character recognition device, are included the codes which are not originally drawn in the drawing, however, are erroneously recognized and extracted.

As compared therewith, since the data of the contents of the specification is not obtained via the optical character recognition device, but characters electronically converted into data are directly read, the data of the contents of the specification does not include the erroneously recognized codes, which is different from the read data of the codes in the drawing 150.

Accordingly, the codes in the drawing 150 which correspond to the codes in the specification can be taken not as the erroneously recognized codes but as the right codes.

As described above, according to the code extracting device 100 of the present embodiment, the codes which are erroneously recognized and read can be eliminated and only the right codes can be left in the codes read from the drawing 150. Accordingly, as shown in, for instance, FIG. 5, when the names are respectively displayed on the drawing 150 correspondingly to the codes, only the right codes can be set as objects to be displayed.

The code extracting device 100 according to the present embodiment is formed in such a way that the codes appearing in the specification are initially extracted (the step S110), and then, the codes appearing in the drawing 150 are extracted (the step 120). However, the code extracting device 100 may be formed in such a way that the codes appearing in the drawing 150 may be initially extracted, and then, the codes appearing in the specification may be extracted.

Further, when the codes appearing in the drawing 150 are extracted, it can be previously selected whether the codes are the numeric characters, the alphabets or both of them. When it is previously understood that the codes as objects to be extracted are any of the numeric characters, the alphabets and both of them, noise (character strings which are erroneously extracted as the codes) during an extraction can be reduced and the codes can be more highly accurately extracted.

### Second Embodiment

In the above-described first embodiment, the codes in the specification are compared with the codes in the drawing 150 and only the codes which respectively correspond to each other are extracted. However, the codes which do not respectively correspond to each other may be extracted.

For instance, in the specification and the drawing for filing a patent application, may be present codes which are described in the specification, however, are not described in the drawing or codes which are not described in the specification, however, are described in the drawing. A control unit 120 may extract such codes.

For instance, when a code “61” is described in the drawing 150, however, the code “61” is not described in the specification, the control unit 120 may extract the code “61” as a mismatched code.

As described above, when the codes which do not respectively correspond to each other in the drawing 150 and the specification are extracted, an erroneous description in the specification and the drawing can be urged to be corrected.

In the above-described first embodiment and the second embodiment, the specification and the drawing for filing the patent application are set as the objects from which the codes are extracted. However, the objects of the code extracting device according to the first embodiment and the second embodiment are not limited to the specification and the drawing for filing the patent application. An object which includes a document and a drawing corresponding thereto as in, for instance, paper presented to an institute or an instruction manual of a machine and tools may be set as the object of the code extracting device according to the first and second embodiments.

Further, in the above-described first and second embodiments, as the codes in the specification and the drawing, only the numeric characters are exemplified, however, foreign languages such as alphabets or Greek numeric characters or combinations of numeric characters and foreign languages may be set as objects as well as the numeric characters.

Here, features of the embodiments of the above-described code extracting method, the code extracting device and the program for carrying out the method according to the present invention are respectively briefly enumerated together in below-described [1] to [6].

[1] A method for extracting codes in a drawing comprises:
a first step (S110) of extracting codes described in a document;
a second step (S120) of extracting codes described in the drawing corresponding to the document:
a third step (S130) of comparing the codes extracted in the first step with the codes extracted in the second step; and
a fourth step (S140) of extracting the codes respectively corresponding to each other in the third step.

[2]: The method according to [1], further comprises:
a fifth step (S150) of extracting the codes that do not respectively correspond to each other in the third step.

[3] A code extracting device comprises an input unit (110); a control unit (120); a storing unit (130); and a display unit (140), wherein
in the storing unit, data is recorded which shows a document and a drawing corresponding to the document inputted through the input unit, and
the control unit extracts codes respectively described in the document and the drawing in accordance with the data showing the document and the drawing which is stored in the storing unit, compares the extracted codes of the document with the extracted codes of the drawing, extracts the codes which respectively correspond to each other and displays the extracted codes on the display unit.

[4] In the code extracting device according to [3], the control unit compares the extracted codes of the document with the codes of the drawing and extracts the codes which do not respectively correspond to each other.

[5] A program which allows a computer to carry out a method for extracting codes described in a document and a drawing corresponding to the document, the program comprises:
a first process (S110) of extracting the codes described in the document;
a second process (S120) of extracting the codes described in the drawing;
a third process (S130) of comparing the codes extracted in the first process with the codes extracted in the second process; and
a fourth process (S 140) of extracting the codes respectively corresponding to each other in the third process.

[6] The program according to [5], further comprises:
a fifth process (S150) of extracting the codes that do not respectively correspond to each other in the third process.

The present invention is described in detail by referring to the specific embodiments, however, it is to be understood to a person with ordinary skill in the art that various changes or modifications may be applied without deviating from the spirit and scope of the present invention.

This application is based on Japanese Patent Application (JPA No. 2013-126501) filed on Jun. 17, 2013 and contents thereof are incorporated herein as a reference.

### INDUSTRIAL APPLICABILITY

According to the code extracting device and the code extracting method of the present invention, since the codes read from the drawing are compared with the codes in the document, the codes which are erroneously recognized and read can be eliminated and only the right codes can be left in the codes of the drawing. The present invention which achieves the above-described effect is available for the method and the device which refer to the document and the drawing corresponding to the document to extract the codes described in the drawing.

### REFERENCE SIGNS LIST

100 . . . code extracting device according to first embodiment of the present invention
110 . . . input unit
120 . . . control unit
130 . . . storing unit
140 . . . display unit

1. A method for extracting codes in a drawing comprising:
a first step of extracting codes described in a document;
a second step of extracting codes described in the drawing corresponding to the document;
a third step of comparing the codes extracted in the first step with the codes extracted in the second step; and
a fourth step of extracting the codes respectively corresponding to each other in the third step.

2. The method according to claim 1, further comprising:
a fifth step of extracting the codes that do not respectively correspond to each other in the third step.

3. A code extracting device comprising an input unit; a control unit; a storing unit; and a display unit, wherein
in the storing unit, data is recorded which shows a document and a drawing corresponding to the document inputted through the input unit, and
the control unit extracts codes respectively described in the document and the drawing in accordance with the data showing the document and the drawing which is stored in the storing unit, compares the extracted codes of the document with the extracted codes of the drawing, extracts the codes which respectively correspond to each other and displays the extracted codes on the display unit.

4. The code extracting device according to claim 3, wherein the control unit compares the extracted codes of the document with the codes of the drawing and extracts the codes which do not respectively correspond to each other.

5. A program which allows a computer to carry out a method for extracting codes described in a document and a drawing corresponding to the document, the program comprising:
a first process of extracting the codes described in the document;
a second process of extracting the codes described in the drawing;
a third process of comparing the codes extracted in the first process with the codes extracted in the second process; and
a fourth process of extracting the codes respectively corresponding to each other in the third process.

6. The program according to claim 5, further comprising:
a fifth process of extracting the codes that do not respectively correspond to each other in the third process.
